(19) United States
(12) Patent Application Publication
(10) Pub. No.: US 2009/0048772 A1
(43) Pub. Date: Feb. 19, 2009

(54) METHOD AND APPARATUS FOR SEARCHING TARGET LOCATION

(75) Inventors: Sang-jun HAN, Seoul (KR); Yoo-tai KIM, Yongin-si (KR); Sang-hee BAHN, Seoul (KR); Yoon-hoe GU, Gwacheon-si (KR); Jung-A KIM, Anyang-si (KR); Yoo-ji KIM, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD., Suwon-si (KR)

(21) Appl. No.: 12/100,636

(22) Filed: Apr. 10, 2008

(30) Foreign Application Priority Data
Aug. 13, 2007 (KR) 10-2007-0081442

(51) Int. Cl. G01C 21/00

(52) U.S. Cl. 701/200

(57) ABSTRACT

Provided are a method and apparatus for searching for a target location using a reference point and a relative location in relation to the reference point, the method comprising receiving a reference point related to the target location; receiving relative location information relating to from the reference point to the target location; and then searching for the target location based on the reference point and the relative location information.

### CROSS-REFERENCE TO RELATED PATENT APPLICATION

This application claims priority from Korean Patent Application No. 10-2007-0081442, filed on Aug. 13, 2007 in the Korean Intellectual Property Office, the disclosure of which is incorporated herein in its entirety by reference.

### BACKGROUND OF THE INVENTION

1. Field of the Invention

Methods and apparatuses consistent with the present invention relate to searching a target location, and more particularly, to searching a target location using a reference point and a relative location in relation to the reference point.

2. Description of the Related Art

As the number of vehicles is continuously increasing, traffic congestion is getting worse. The problem is that the increase in number of vehicles is much faster than the expansion of roads or other transportation facilities. As one of the solutions to solve such traffic congestion, a navigation system has been developed. Such navigation system receives location information transmitted by a global position system (GPS) satellite and determines the present location of a moving object based on the received location information and then displays the present location of the moving object by matching the received location information to predetermined map data.

Using the navigation system, a driver of a moving object can check the present location of the moving object and the shortest route from the present location to a target location, and thus, can efficiently use a driving route that the moving object will follow according to the guidance of the navigation system.

FIGS. 1A through 1D illustrate an example of a related art method of searching for a target location.

In FIG. 1A, it is easy to find a target location that the user wishes to find when the target location is registered in the map data and the user knows the exact name of the target location. However, when the target location is not registered in the map data or the user does not know the exact name of the target location, the user has to search for the target location directly on the screen on which arbitrary locations are displayed.

FIG. 1B is a screen on which arbitrary locations are displayed from a first search, as shown in FIG. 1A.

The user searches for the target location on the screen on which arbitrary locations are displayed. In the related art, the user directly searches for the target location by using a touch screen.

In FIG. 1C, once the target location is found from the first search in FIG. 1B, the user sets the target location as the destination.

In FIG. 1D, a guidance route to the destination can be started.

Like this, it is substantially impossible to register all the buildings or points in the map data, and if the target location the user wishes is not registered in the map data or when the user does not know the exact name of the target location, the target location needs to be searched by performing several operations such as searching arbitrary locations, searching for the target location on the screen on which arbitrary locations are displayed, and, once the target location is found, setting the target location as the destination.

In particular, since an ordinary navigation apparatus employs a small display unit of 3-4 inches, it is difficult to search for the target location accurately and the displayed screen needs to be enlarged or reduced several times to search for the target location. Moreover, if there are two or more identical names for the arbitrary target location of the first search, the above-described operations need to be repeated.

### SUMMARY OF THE INVENTION

The present invention provides a method and apparatus for searching for a target location in order to efficiently search for a target location even when the absolute location of the target location cannot be searched.

According to an aspect of the present invention, there is provided a method of searching for a target location, the method comprising: receiving a reference point related to the target location; receiving relative location information relating to location relationships between the reference point and the target location; and searching for the target location based on the reference point and the relative location information.

The receiving of the relative location information may comprise: requesting input of the relative location information; and receiving the relative location information corresponding to the request.

In the requesting of the input of the relative location information, a relative location information list in which detailed items representing the relative location information are listed may be output, and in the receiving of the relative location information, at least one of the detailed items may be received as the relative location information corresponding to the output relative location information list.

The method may further comprise managing the relation location information list for at least one of addition, modification, and deletion of the detailed items included in the relative location information list.

The relative location information may be at least one of direction information from the reference point to the target location and distance information from the reference point to the target location.

The direction information to the target location may include at least one of ‘left’, ‘right’, ‘make a left’, ‘make a right’, and ‘opposite to’, and the distance information to the target location may include at least one of ‘100 m’ ‘200 m’, and ‘one block’.

The relative location information may include first relative location information and second relative location information, and the searching for the target location may comprise: searching for a first target location based on the reference point and the first relative location information; and searching for a final target location based on the first target location and the second relative location information.

The method may be performed in a navigation device of a mobile terminal to guide a moving path of the mobile terminal.

The location relationships may correspond to information from the reference point to the target location.

According to another aspect of the present invention, there is provided an apparatus of searching for a target location, comprising: an interface unit which receives a reference point related to the target location and relative location information relating to the location relationships between the reference point and the target location; and a target location searching unit which searches for the target location based on the reference point and the relative location information.

### BRIEF DESCRIPTION OF THE DRAWINGS

The above and other aspects of the present invention will become more apparent by describing in detail exemplary embodiments thereof with reference to the attached drawings in which:

FIG. 1A through 1D are an example of a related art method of searching for a target location;

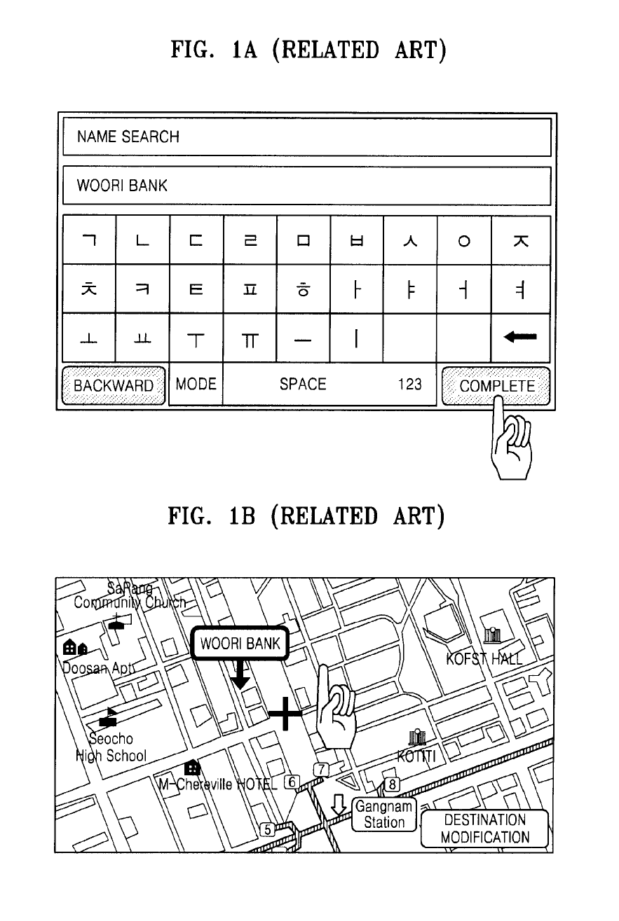

FIG. 2 is a block diagram of a target location searching apparatus 200 according to an exemplary embodiment of the present invention;

FIG. 3 is a relative location information list 300 that provides relative location information, according to an exemplary embodiment of the present invention;

FIG. 4 is a target location searching process according to an exemplary embodiment of the present invention;

FIG. 5 is a target location searching process according to another exemplary embodiment of the present invention; and

FIG. 6 is a flowchart illustrating a method of searching for a target location according to an exemplary embodiment of the present invention.

### DETAILED DESCRIPTION OF EXEMPLARY EMBODIMENTS OF THE INVENTION

The present invention will now be described more fully with reference to the accompanying drawings, in which exemplary embodiments of the invention are shown.

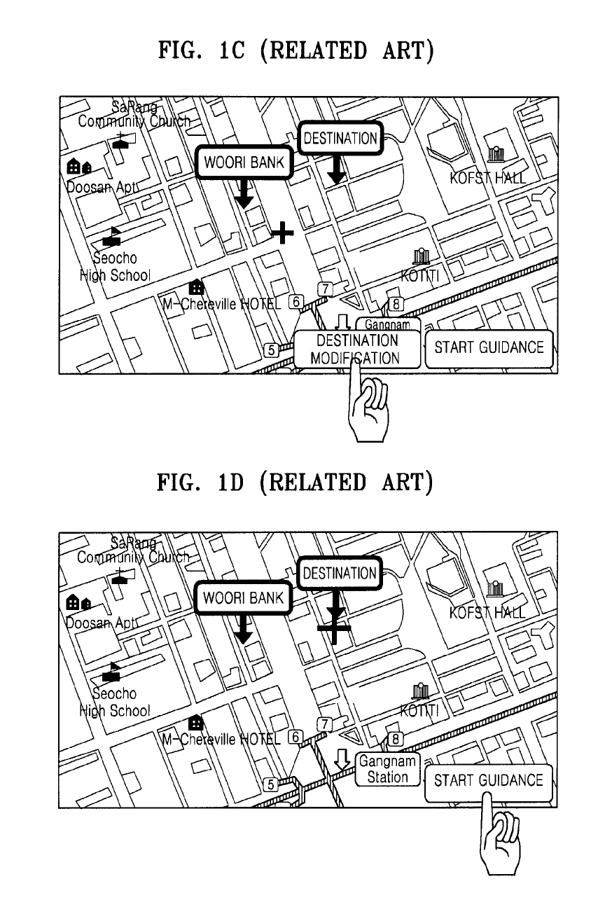

FIG. 2 is a block diagram of a target location searching apparatus 200 according to an exemplary embodiment of the present invention.

The target location searching apparatus 200 according to the present invention can be operated in a navigation device of a mobile terminal to guide a moving path of the mobile terminal. The target location searching apparatus 200 includes an interface unit 210 and a target location searching unit 220.

The interface unit 210 receives a reference point related to a target location, and relative location information relating to location relationships between the reference point and the target location. The location relationships may correspond to information from the reference point to the target location.

The target location searching unit 220 searches for the target location based on the reference point and the relative location information input to the interface unit 210.

The interface unit 210 may include a first interface unit to receive a reference point and a second interface unit to receive relative location information. Alternatively, one interface unit may receive both a reference point and relative location information.

According to the present invention, a reference point denotes a point that can be referred to in order to find a target location. For example, when a user is looking for a coffee shop named ‘COMEON’ which is located near the Kyo-dae neighborhood, and if the coffee shop named ‘COMEON’ or its specific address is not known or the coffee shop named ‘COMEON’ is not registered in the map data, then other registered names or addresses such as ‘Kyo-dae Station Exit No. 14’ can be appointed as a reference point. There is no particular restriction to the reference points that can be input.

A reference point can be input in various manners. For example, user can input the name or the address of the reference point directly or its initial syllable as reference point. Also, user can input the reference point by characters or by voice.

In addition, according to exemplary embodiments of the present invention, the relative location information denotes relative location information representing location relationships between the reference point input to the interface unit 210 and the target location. The relative location information may be any information that represents relative locations; for example, the relative location information may be direction information such as ‘left’, ‘right’, etc., representing directions from the reference point to the target location, or distance information such as ‘100 m’, ‘200 m’, etc., representing distances from the reference point to the target location. Particularly, the relative location information may be in the form of informal language including ‘make a left, ‘make a right’, ‘opposite to, ‘one block’, ‘two blocks’, etc. In addition, the relative location information may include both direction information and distance information, for example, ‘make a left one block’ from the reference point to arrive at the target location.

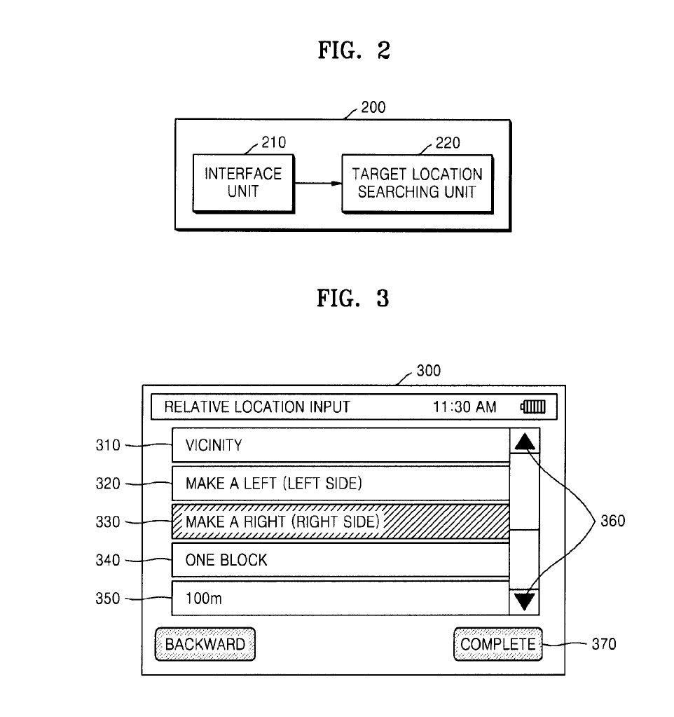

The relative location information can be input in various manners. Like the reference point, the relative location information can be input directly. Also, the target location searching apparatus 200 may further include an output unit (not shown). In this case, when output unit requests input of the relative location information, the user inputs the relative location information directly to the interface unit 210. For example, when the output unit outputs a relative location information list in which detailed items representing relative location information are listed, user can select at least one of the detailed items as the relative location information using the interface unit 210. An example of the relative location information list will be described later with reference to FIG. 3.

When the relative location information is input from the relative location information list of the output unit as in the above-described example, a list manager (not shown) managing addition, modification, and deletion of the detailed items included in the relative location information list may be further included. The detailed items included in the relative location information list can be renewed with ones that are frequently used or ones with higher preference through the list manager.

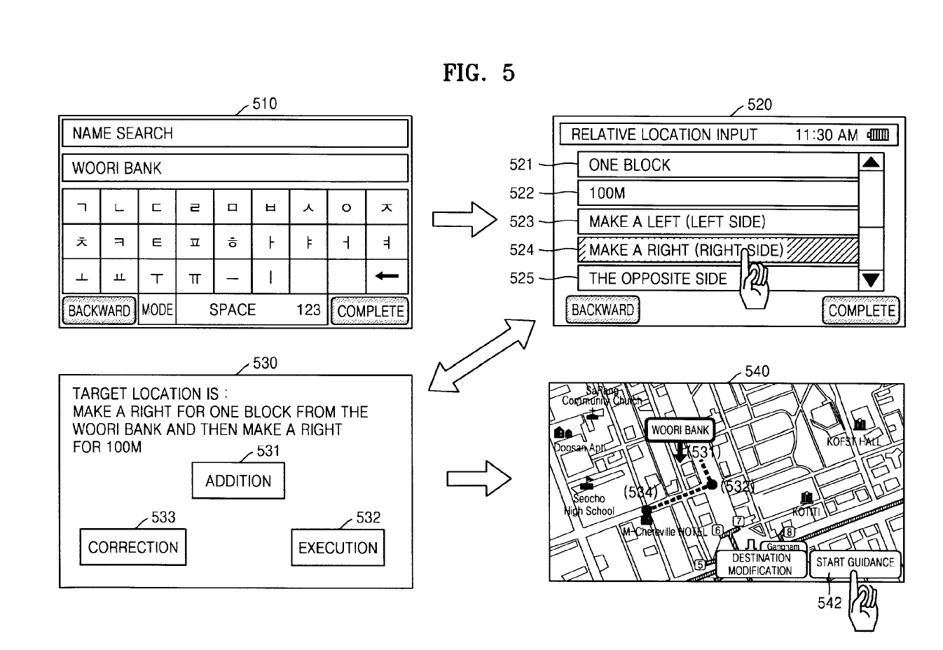

The relative location information may include first relative location information and second relative location information. That is, when searching for a target location, two or more relative location information can be used. Then, in this case, first target information can be searched based on the reference point and the first relative location information, and then a final target location can be searched based on the first target location and the second relative location information. A process of searching for a target location using two or more relative locations information will be described later with reference to FIG. 5.

FIG. 3 is a relative location information list 300 that provides relative location information, according to an exemplary embodiment of the present invention.

The relative location information list 300 includes a plurality of detailed items 310 through 350 which represent relative location information. The detailed items 310, 320, and 330 included the relative location information list 300 represent direction information from the reference point to the target location and the detailed items 340 and 350 included the relative location information list 300 represent distance information from the reference point to the target location. The relative location information list 300 may include more detailed items than the ones shown, and thus, the present exemplary embodiment is not limited to the ones shown. Thus, the user can view the detailed items by moving a scroll 360. The user selects one of the detailed items 310 through 350 that is appropriate in relation to location relationship information from a reference point to a target location. In the current exemplary embodiment of the present invention, the user selects the detailed item 330 called “make a right” and then presses a complete button 370 to set the “make a right” from the reference point as a target location.

The relative location information list 300 according to the present invention is provided automatically to the user when the user inputs a reference point. However, the relative location information list 300 may also be provided to the user only when the user voices out for the relative location information list 300.

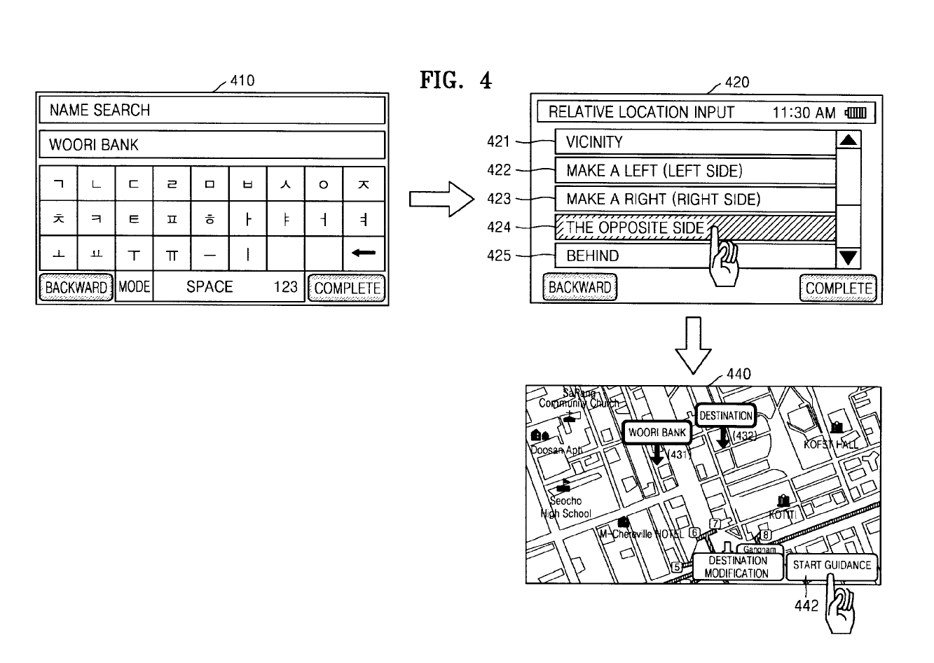

FIG. 4 is a target location searching process according to an exemplary embodiment of the present invention.

The user inputs a reference point that can be input in various manners; however in the current exemplary embodiment, the name of the reference point is directly input to a window 410 that is provided for inputting reference points. In the present exemplary embodiment, the reference point is “Woori Bank”, also shown as Woori bank (431) in FIG. 4. If the user does not additionally input a relative location, the reference point is assigned as a target location.

The user inputs the relative location information relating to from the reference point to the target location. The relative location information can be input in various manners; however in the current exemplary embodiment, detailed items 421 through 425 representing relative location information are output to a display device through the window 410, and at least one of the detailed items 421 through 425 in a relative location information list 420 is selected by the user, thereby inputting relative location information relating to location relationship information between the reference point and the target location. In the current exemplary embodiment, for example, the user selects the detailed item 424 called “opposite to” as the relative location information.

Target location searching apparatus 200 searches for the target location using the reference point and the relative location information. The user selects “Woori Bank” as the reference point and ‘opposite to’ as the relative location information, and thus ‘opposite to’ the Woori Bank (431) is appointed as the target location (432). When the user presses a guidance start button 442 guidance to the target location (432) is started.

FIG. 5 is a target location searching process according to another exemplary embodiment of the present invention,

Here, it is assumed that the interface in FIG. 5 through which the reference point and the relative location information are input is identical to that of the one illustrated in FIG. 4. The user directly inputs the reference point using the name of the reference point that is directly input to a window 510 for inputting a reference point, and thus the reference point is “Woori Bank”, as illustrated in FIG. 4.

The user inputs relative location information relating to location relationships from the reference point to the target location. In the current exemplary embodiment of the present invention, a relative location information list 520 in which detailed items 521 through 525 representing relative location information are listed is output, and then, the user selects at least one of the detailed items 521 through 525 from the relative location information list 520 to input the relative location information. In the present exemplary embodiment, the user selects the detailed item 524 called “make a right” as the relative location information in relation to the reference point.

The user may input one reference point and one relative location information; however to more accurately search for a target location, the user may also input a plurality of relative location information instead of simply one.

When the user inputs the plurality of relative location information, the output unit may output a window frame 530 for question to user whether the user would like to further input more relative location information. When the user wants to input more relative location information, the user clicks an addition button 531, and when the user wants to search for the target location using the previously input relative location information, the user clicks an operation button 532. In addition, when the user wants to correct the previous input relative location information, the user clicks a correction button 533.

When the user clicks the addition button 531, the relative location list 520 in which the detailed items 521 through 525 representing relative location information are listed is output again, and the user selects a desired detailed item from among the detailed items 521 through 525. In the present exemplary embodiment, it is assumed that the user consecutively selects the detailed items 524, 521, 524, and 522 respectively called “make a right”, “one block”, “make a right”, and “100 m” as the plurality of relative location information in the above-described manner.

The target location is searched using the reference point and the plurality of relative location information input by the user. If the user inputs “Woori Bank” as the reference point, and selects the detailed items 524, 521, 524, and 522, respectively called “make a right”, “one block”, “make a right”, and “100 m” as the plurality of relative location information, the target location can be reached by making a right for one block from the Woori Bank (531), and then make a right for 100 m. Accordingly, when the user presses a guidance start button 542 guidance to the target location 534 is started.

In the current exemplary embodiment of the present invention, a target location is searched for by using one reference point and one relative location information or more. However, a target location can also be searched for by using two or more reference points, and relative location information with respect to each reference point.

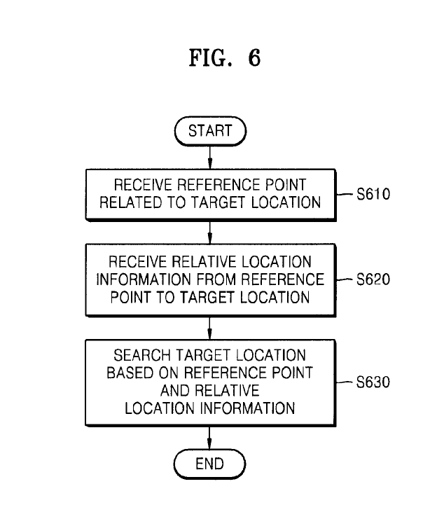

FIG. 6 is a flowchart illustrating a method of searching for a target location according to an exemplary embodiment of the present invention.

In operation S610, a reference point related to a target location is input.

In operation S620, relative location information from the reference point to the target location is input. The operation S620 may further include requesting input of relative location information. This request may be performed by outputting a relative location information list in which detailed items representing relative location information are listed. When the operation S620 further includes requesting input of relative location information, relative location is input based on the input corresponding to the request, and when the relative location information list is output, at least one detailed item can be selected as relative location information based on the input.

The relative location information may be at least one of direction information from the reference point to the target location and distance information to the target location. Also, the relative location information may include informal language including ‘one block’, ‘make a right hand”, and ‘opposite to’ representing the relative location from the reference point to the target location.

In operation S630, the target location is searched based on the reference point and the relative location information. When the relative location information include two or more, for example, first relative location information and second relative location information, a first target location is searched based on the reference point and the first relative location information, and a final target location is searched based on the first target location and the second relative location information.

According to the present invention, a target location is searched by using a reference point and a relative location from the reference point to target location. So, target location can be input easily and the target location can be searched easily even when the absolute location of the target location is not available or the target location is not registered in the map data.

The exemplary embodiments of the present invention can be written as computer programs and can be implemented in general-use digital computers that execute the programs using a computer readable recording medium.

Examples of the computer readable recording medium include magnetic storage media (e.g., ROM, floppy disks, hard disks, etc.), optical recording media (e.g., CD-ROMs, or DVDs), and storage media such as carrier waves (e.g., transmission through the Internet).

While the present invention has been particularly shown and described with reference to exemplary embodiments thereof, it will be understood by one skilled in the art that various changes in form and details may be therein without departing from the spirit and scope of the invention as defined by the appended claims. Accordingly, the exemplary embodiments should be considered in a descriptive sense only, and not for purpose of limitation. The scope of the invention is defined not by the detailed description of the invention but by the appended claims, and all differences within the scope will be construed as being included in the present invention.

What is claimed is:

1. A method of searching for a target location, the method comprising:
receiving a reference point related to the target location;
receiving relative location information relating to location relationships between the reference point and the target location; and
searching for the target location based on the reference point and the relative location information.

2. The method of claim 1, wherein the receiving of the relative location information comprises:
requesting input of the relative location information; and
receiving the relative location information corresponding to the request.

3. The method of claim 2, wherein in the requesting of the input of the relative location information, a relative location information list, in which detailed items representing the relative location information are listed, is output, and
in the receiving of the relative location information, at least one of the detailed items is received as the relative location information corresponding to the output relative location information list.

4. The method of claim 3, further comprising managing the relation location information list for at least one of addition, modification, and deletion of the detailed items included in the relative location information list.

5. The method of claim 1, wherein the relative location information is at least one of direction information from the reference point to the target location and distance information from the reference point to the target location.

6. The method of claim 5, wherein the direction information to the target location includes at least one of ‘left’, ‘right’, ‘make a left’, ‘make a right’, and ‘opposite to’, and
the distance information to the target location includes at least one of ‘100 m’ ‘200 m’, and ‘one block’.

7. The method of claim 1, wherein the relative location information includes first relative location information and second relative location information, and the searching for the target location comprises:
searching for a first target location based on the reference point and the first relative location information; and
searching for a final target location based on the first target location and the second relative location information.

8. The method of claim 1, wherein the method of searching for target location is performed in a navigation device of a mobile terminal to guide a user of the mobile terminal.

9. The method of claim 1, wherein the location relationships correspond to information from the reference point to the target location.

10. An apparatus of searching for a target location, comprising:
an interface unit which receives a reference point related to the target location and relative location information relating to the location relationships between the reference point and the target location; and
a target location searching unit which searches for the target location based on the reference point and the relative location information.

11. The apparatus of claim 10, further comprising an output unit which requests input of the relative location information,
wherein the interface unit receives the relative location information corresponding to the request of the output unit.

12. The apparatus of claim 11, wherein the output unit outputs a relative location information list in which detailed items representing the relative location information are listed, and
the interface unit receives at least one of the detailed items as the relative location information.

13. The apparatus of claim 12, further comprising a list manager which manages at least one of addition, modification, and deletion of the detailed items included in the relative location information list.

14. The apparatus of claim 10, wherein the relative location information is at least one of direction information from the reference point to the target location and distance information from the reference point to the target location.

15. The apparatus of claim 14, wherein the direction information to the target location includes at least one of ‘left’, ‘right’, ‘make a left’, ‘make a right’, and ‘opposite to’, and
the distance information to the target location includes at least one of ‘100 m’, ‘200 m’, and ‘one block’.

16. The apparatus of claim 10, wherein the relative location information includes first relative location information and second relative location information, and the searching for the target location comprises:
searching for a first target location based on the reference point and the first relative location information; and
searching for a final target location based on the first target location and the second relative location information.

17. The apparatus of claim 10, wherein the apparatus is in a navigation device of a mobile terminal to guide a user of the mobile terminal.

18. The apparatus of claim 10, wherein the relative location information corresponds to location relationships between the reference point and the target location.

19. A computer readable medium storing a computer program performing a method of searching for a target location, the method comprising:
receiving a reference point related to the target location;
receiving relative location information relating to location relationships between the reference point and the target location; and
searching for the target location based on the reference point and the relative location information.
